(19) United States
(12) Patent Application Publication
(10) Pub. No.: US 2013/0282452 A1
(43) Pub. Date: Oct. 24, 2013

(54) Advertisement Revenues Shared With Subscribers

(71) Applicant: Jianping He, Edison, NJ (US)

(72) Inventor: Jianping He, Edison, NJ (US)

(21) Appl. No.: 13/454,066

(22) Filed: Apr. 23, 2012

(51) Int. Cl. G06Q 30/02

(52) U.S. Cl. 705/14.7

(57) ABSTRACT

The present invention provides a method, system and program product for the owners (also known as “subscribers”) of communication devices such as smart TVs, computers, notebooks, mobile phones and tablets, to auction, rent or lease parts or all of their device display screens where advertisers can bid to display advertisements directly or through advertising providers. The device display screen auction, rental or lease can be based on timeslot such as a number of seconds, minutes, hours and days. In addition, subscribers may define selection criteria such as countries, languages, categories, personal interests, device locations and other meta-data to filter out advertisements for displays on their devices. The advertisement revenues on device display screens of communication devices are shared among subscribers, advertising providers and related third party partners based on contracts or agreements.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Advertisement is an important part of business and economy. There are various kinds of advertisements, such as TV advertisements, online advertisements, mobile advertisements, etc. With the advance of technology, it is becoming more and more common to display advertisements through mobile devices and social networks.

Typically, advertising providers receive advertisements from advertisers, advertising networks or advertising exchanges, and then sends advertisements to publishers which deliver advertisements to subscribers via communication devices such as TVs, computers, notebooks, mobile phones, tablets, etc. The advertisement revenues are shared among publishers, advertising providers and related third party partners based on contracts or agreements.

There are a few issues in the traditional advertisement model. First, subscribers are not the receivers of shared advertisement revenues at all. People spend money to buy TVs and spend time to watch TV advertisements, but they don't get compensated for either their views or advertisement displays on their TVs. Internet or mobile users views and/or clicks advertisements from their computers or phones. They are the main generators of online or mobile advertisement revenues, but don't get paid for either their actions or advertisement displays on their communication devices.

Second, even though there is more and more behavioral targeting and contextual advertising, subscribers cannot control advertisement contents displayed on their communication devices. The advertisement selection is merely the result of the best-effort process and coordination from advertisers, advertising providers and publishers.

Therefore, there is a need to provide an optimized solution for subscribers to share advertisement revenues with advertising providers and publishers.

### BRIEF SUMMARY OF THE INVENTION

The present invention provides a method, system and program product for the owners (also known as “subscribers”) of communication devices such as smart TVs, computers, notebooks, mobile phones and tablets, to auction, rent or lease parts or all of their device display screens where advertisers can bid to display advertisements directly or through advertising providers. The device display screen auction, rental or lease can be based on timeslot such as a number of seconds, minutes, hours and days. The advertisement revenues on device display screens of communication devices are shared among subscribers, advertising providers and related third party partners based on contracts or agreements.

For example, a subscriber wishes to get paid for advertisement display on his mobile phone and decides to auction spaces of his mobile phone home screen for four advertisements at a time. In order to achieve his goal, the subscriber configures his mobile phone home screen logically into four equal sections: Section-A, Section-B, Section-C and Section-D. Each section will be auctioned to host one advertisement. Section-A and Section-B have ask-price $1.00/day and $2.00/day respectively, while Section-C and Section-D have ask-price $0.10/hour and $0.20/hour respectively. On the other hand, an advertiser has four advertisements ready for display service: advertisement-A and advertisement-B with bid-price $1.00/day and $2.00/day respectively, while advertisement-C and advertisement-D with bid-price $0.10/hour and $0.20/hour respectively. In such scenario, advertisement-A is a candidate for Section-A but not for Section-B, Section-C and Section-D; advertisement-B is a candidate for Section-A and Section-B but not for Section-C and Section-D; advertisement-C is a candidate for Section-C but not for Section-A, Section-B and Section-D; advertisement-D is a candidate for Section-C and Section-D but not for Section-A and Section-B.

In addition, subscribers may define selection criteria such as countries, languages, categories, personal interests, device locations and other meta-data to filter out advertisements for displays on their devices. Continue with the above example. Assume Section-A and Section-D allow advertisements in finance category, while Section-B and Section-C allow advertisements in health category. Also assume advertisement-A, advertisement-B, advertisement-C, and advertisement-D belong to category finance, finance, health, and health respectively. Then advertisement-A and advertisement-B can be candidates only for Section-A, while advertisement-C and advertisement-D can be candidates only for Section-C. Since advertisements with higher bid win, advertisement-B will be hosted on Section-A, while advertisement-D will be hosted on Section-C. Assume there are no other advertisements. Then both Section-B and Section-D will not host any advertisement. Assume the mobile phone is on for the whole day, then one-day revenue is $2.00+24×$0.20=$6.80, and will be shared by the subscriber and others.

### BRIEF DESCRIPTION OF THE SEVERAL VIEWS OF THE DRAWING

FIG. 1 illustrates perspective architecture of a communication device, in accordance with one embodiment of the present invention.

FIG. 2 illustrates perspective display screen of a communication device, in accordance with one embodiment of the present invention.

FIG. 3 illustrates perspective architecture of an advertisement system, which connects subscribers, communication devices and display sections, advertisers, advertising providers, advertising networks and advertising exchanges through communication networks, in accordance with one embodiment of the present invention.

### DETAILED DESCRIPTION OF THE INVENTION

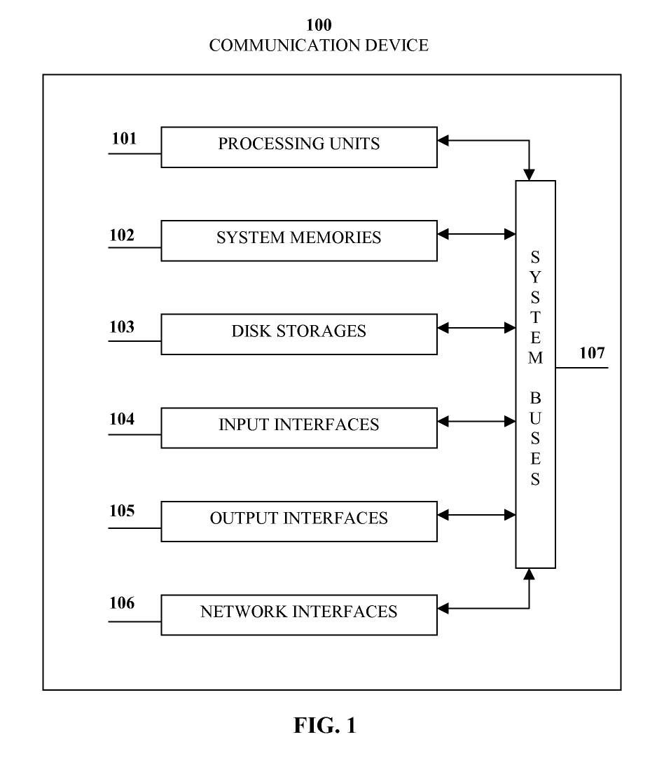

FIG. 1 illustrates perspective architecture of a communication device. In one embodiment, the Communication Device 100 comprises Central Processing Units 101, System Memories 102, optional Disk Storages 103, Input Interfaces 104, Output Interfaces 105, Network Interfaces 106 and System Buses 107.

The Central Processing Units 101 provide a means for executing executable programs and can be any types of micro-controllers, processors, micro-processors, or multi-processors. The System Memories 102 provide a means for storing executable programs such as a basic input/output system (BIOS), one or more operating systems, a plurality of firmware modules, and a plurality of software modules. The System Memories 102 can be any combinations of random-access memory (RAM) and read-only memory (ROM). The Disk Storages 103 provide a means for storing programs, files and data, and can be any types of internal and external magnetic disks, optical disks, and the like.

The Input Interfaces 104 provide a means for transferring data into the Communication Device 100 through input components and/or devices (not shown) such as keyboard, keypad, touch-pad, touch screen, thumb-wheel, trackball, mouse, stylus, joystick, microphone, camera, sensor, etc. The Output Interfaces 105 provide a means for transferring data from the Communication Device 100 to output components and/or devices (not shown) such as screen, display, television, speaker, etc. The display screen(s) of the Communication Device 100 can be used for either input interfaces, or output interfaces, or both, and can be either built-in components or external ones attached to the Communication Device 100.

The Network Interfaces 106 provide a means for transferring data between the Communication Device 100 and other communication devices (not shown) through wired and/or wireless communication networks (not shown) such as cable networks, cellular networks, circuit-switched telephone networks and packet-switched data networks.

The System Buses 107 provide a means for transferring data internally among the Central Processing Units 101, the System Memories 102, the Disk Storages 103, the Input Interfaces 104, the Output Interfaces 105, the Network Interfaces 106, and other components (not shown) of the Communication Device 100.

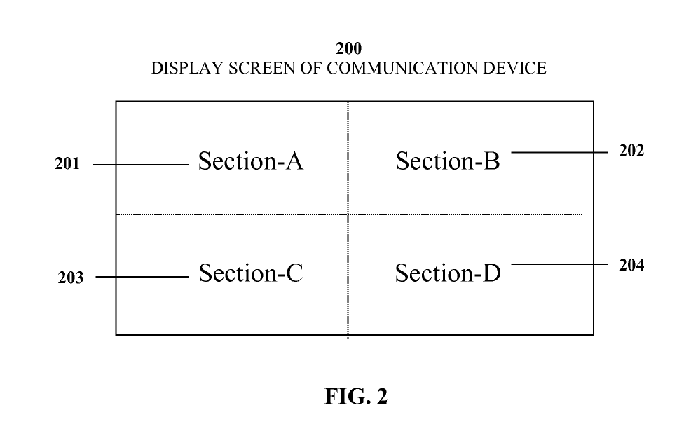

Reference is now to FIG. 2, which illustrates perspective display screen of a Communication Device 100 described in FIG. 1. The display screen can be treated as one display section, or logically as groups of display sections for the purpose of advertisement. Here, as one example, the Display Screen 200 is logically divided into four equal display sections, labeled as Section-A 201, Section-B 202, Section-C 203 and Section-D 204 respectively. Each display section can be auctioned, rent or leased to host an advertisement independently.

Normally the Communication Device 100 has only one home screen which spans the whole display screen and shows up by default when the Communication Device 100 powers on or does not execute any application task. Some advanced communication devices such as smart-phones may have more than one home screen (virtual home screen), each spanning the whole display screen when selected, touched or tapped. Parts or all of home screens of communication devices would be the natural places to host advertisements.

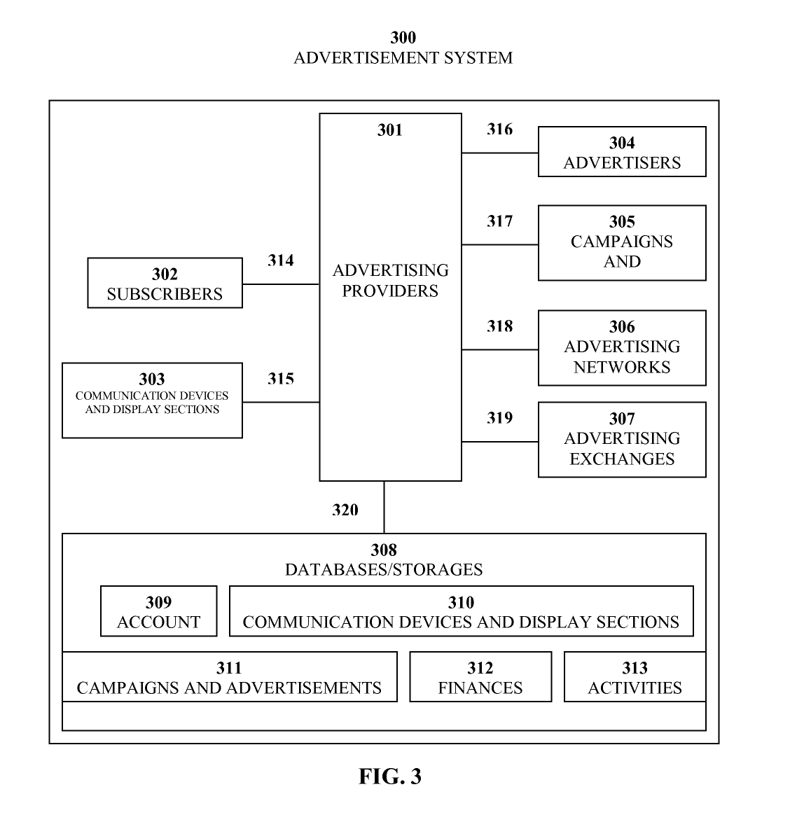

Reference is now to FIG. 3, which illustrates architecture of an exemplary advertisement system. An advertiser in the Advertisers 304 can register an account with an advertising provider in the Advertising Providers 301 through the Interfaces 316 which can be the portals or application-programming-interfaces (APIs) of the advertising provider, or third party interfaces associated with the advertising provider. The account information may comprise name, mailing address, email address, phone number, company name, account type, etc. After account registration, the advertiser can create advertising campaigns and advertisements with the advertising provider through the Interfaces 317 which can be the portals or application-programming-interfaces (APIs) of the advertising provider, or third party interfaces associated with the advertising provider. An advertising campaign is groups of advertisements with the same theme during certain timeframe to promote company, organization, product, brand, website, event, etc. For each specific advertising campaign, the advertiser can setup total budget, budget rate (per second, per minute, per hour, per day, per week, per month and per year), default advertisement bid price, and default targeting criteria (device manufacture and model, device platform and operating system, service provider or operator, country and language, data traffic type, category, location, personal interest, online or mobile activity and transaction, etc.). Each advertisement may be associated with advertisement meta-data (name, URL, promotion, etc.), creative meta-data (text, image, audio, video, file size, display time, etc.), click-for-action (sending emails, sending SMSs, calling phone numbers, browsing websites, listening musics, playing games, watching movie trailers, etc.), and override default bid-price and targeting criteria defined in respective campaign. Before campaigns and advertisements can be effective, they must be funded by the advertiser and approved by the advertising provider.

The advertising provider can also get advertisements from the Advertising Networks 306 through the Interfaces 318, and the Advertising Exchanges 307 through the Interfaces 319. The Interfaces 318 and the Interfaces 319 can be the portals or application-programming-interfaces (APIs) of the advertising provider, or third party interfaces associated with the advertising provider.

A subscriber in the Subscribers 302 can register an account with an advertising provider in the Advertising Providers 301 through the Interfaces 314 which can be the portals or application-programming-interfaces (APIs) of the advertising provider, or third party interfaces associated with the advertising provider. The account information may comprise name, mailing address, email address, phone number, company name, account type, etc. After account registration, the subscriber can register his devices and display screen sections with the advertising provider through the Interfaces 315 which can be the portals or application-programming-interfaces (APIs) of the advertising provider, or third party interfaces associated with the advertising provider. For a registered communication device, its display screen(s) can be logically divided into a number of sections, each of which can be configured to host an advertisement. The subscriber may define a rule to select advertisement or choose any advertisement from the advertising provider for each display section. In addition, for a registered communication device, special module(s) inside the device functioning as advertisement process engine, can send advertisement selection criteria and advertisement requests to, and receive advertisements from the advertising provider. The special module(s) can be either firmware module(s) or software module(s), either built-in or downloaded to communication devices. After advertisements are displayed by special module(s) on display sections, revenues are realized and shared among the subscriber, the advertising provider and related third party partners based on contracts or agreements.

The Databases/Storages 308 are the information repository for the advertising provider. They can be internal parts of the advertising provider, or external but accessible to the advertising provider through the Network Interface 320. They comprise data of Accounts 308 from subscriber and advertiser registrations, data of Communication Devices and Display Sections 310 from device and display section registrations, data of Finances 312, data of Activities 313, data of Campaigns and Advertisements 311 from Advertisers 304, Advertising Networks 306 and Advertising Exchanges 307.

The Finances 312 record financial accounts (banks, credit cards, etc.), tax information, funds and balances, associated with each subscriber and advertiser. The Activities 313 comprise campaign and advertisement statistics and reports such as impressions, clicks and costs for advertisers, device and display section rental, lease and auction statistics and reports such as advertisement requests and revenues for subscribers.

While the present invention has been described with respect to a limited number of embodiments, those skilled in the art will appreciate numerous modifications and variations therefrom. It is intended that the appended claims cover all such modifications and variations as fall within the true spirit and scope of the present invention.

What is claimed is:

1. A method providing advertisement revenues shared among subscribers, advertising providers and related third party partners, the method comprising:
registering accounts by advertisers with said advertising providers;
creating campaigns and advertisements, setting up budget rates and totals, advertisement bid prices and targeting criteria by said advertisers with said advertising providers;
funding said campaigns and advertisements by said advertisers;
approving said campaigns and advertisements by said advertising providers;
starting said campaigns and making said advertisements ready for delivery and display;
registering accounts by said subscribers with said advertising providers;
registering communication devices by said subscribers with said advertising providers;
for each said communication device, logically dividing parts or all of its device display screens into a plurality of display sections, each of them can be auctioned, leased or rent to host an advertisement based on selection criteria such as category, country, language, device location, personal interest and timeslot such as a number of seconds, minutes, hours and days.
sending requests for advertisement from said communication devices to said advertising providers through advertisement process engines, which can be built-in modules on or downloaded to said communication devices;
receiving responses for advertisement from said advertising providers to said communication devices through said advertisement process engines;
displaying said advertisements on said display sections of said communication devices through said advertisement process engines;
optionally executing click-for-actions for said advertisements on said communication devices by said subscribers;
charging said advertisers by said advertising providers based on contracts or agreements, and impressions or actions for said advertisements during effective timeframes of said campaigns;
distributing advertisement revenues among said subscribers, said advertising providers and said related third party partners by said advertising providers based on contracts or agreements.

2. The method as claimed in claim 1, wherein account registrations from said advertisers and said subscribers, creations of said campaigns and advertisements from said advertisers, device registrations and display section registrations from said subscribers, said requests from and said responses to said advertisement process engines, can be done through communication networks with the portals or application programming interfaces of said advertising providers, or third party interfaces associated with said advertising providers.

3. The method as claimed in claim 1, wherein said subscribers are the owners of said communication devices; wherein said communication devices comprise one or more components of central processing units, system memories, disk storages, input interfaces, output interfaces, network interfaces and system buses. The display screens of said communication devices can be either built-in components or external ones attached to said communication devices.

4. The method as claimed in claim 1, wherein said targeting criteria for said campaigns and advertisements from said advertisers comprise one or more characteristics of device manufactures and models, device platforms and operating systems, service providers or operators, countries and languages, data traffic types, categories, device locations, personal interests, online or mobile activities and transactions.

5. The method as claimed in claim 1, wherein said campaigns and advertisements can also come from advertising networks and advertising exchanges.

6. A system providing advertisement revenues shared among subscribers, advertising providers and related third party partners, the system comprising:
communication devices;
said subscribers;
advertisers;
said advertising providers;
advertising networks;
advertising exchanges;
communication networks connecting said subscribers, said communication devices, said advertisers, said advertising networks and said advertising exchanges with said advertising providers; and performing the acts of:
registering accounts by said advertisers with said advertising providers;
creating campaigns and advertisements, setting up budget rates and totals, advertisement bid prices and targeting criteria by said advertisers with said advertising providers;
funding said campaigns and advertisements by said advertisers;
approving said campaigns and advertisements by said advertising providers;
starting said campaigns and making said advertisements ready for delivery and display;
registering accounts by said subscribers with said advertising providers;
registering communication devices by said subscribers with said advertising providers;
for each said communication device, logically dividing parts or all of its device display screens into a plurality of display sections, each of them can be auctioned, leased or rent to host an advertisement based on selection criteria such as category, country, language, device location, personal interest and timeslot such as a number of seconds, minutes, hours and days.
sending requests for advertisement from said communication devices to said advertising providers through advertisement process engines, which can be built-in modules on or downloaded to said communication devices;
receiving responses for advertisement from said advertising providers to said communication devices through said advertisement process engines;
displaying said advertisements on said display sections of said communication devices through said advertisement process engines;
optionally executing click-for-actions for said advertisements on said communication devices by said subscribers;
charging said advertisers by said advertising providers based on contracts or agreements, and impressions or actions for said advertisements during effective timeframes of said campaigns;
distributing advertisement revenues among said subscribers, said advertising providers and said related third party partners by said advertising providers based on contracts or agreements.

7. The method as claimed in claim 6, wherein account registrations from said advertisers and said subscribers, creations of said campaigns and advertisements from said advertisers, device registrations and display section registrations from said subscribers, said requests from and said responses to said advertisement process engines, can be done through said communication networks with the portals or application programming interfaces of said advertising providers, or third party interfaces associated with said advertising providers.

8. The method as claimed in claim 6, wherein said subscribers are the owners of said communication devices; wherein said communication devices comprise one or more components of central processing units, system memories, disk storages, input interfaces, output interfaces, network interfaces and system buses. The display screens of said communication devices can be either built-in components or external ones attached to said communication devices.

9. The method as claimed in claim 6, wherein said targeting criteria for said campaigns and advertisements from said advertisers comprise one or more characteristics of device manufactures and models, device platforms and operating systems, service providers or operators, countries and languages, data traffic types, categories, device locations, personal interests, online or mobile activities and transactions.

10. The method as claimed in claim 6, wherein said campaigns and advertisements can also come from said advertising networks and said advertising exchanges.

11. A program product comprising executable instructions embodied in readable media of advertising providers and communication devices for providing advertisement revenues shared among subscribers, advertising providers and related third party partners, the program product comprising:
registering accounts by advertisers with said advertising providers;
creating campaigns and advertisements, setting up budget rates and totals, advertisement bid prices and targeting criteria by said advertisers with said advertising providers;
funding said campaigns and advertisements by said advertisers;
approving said campaigns and advertisements by said advertising providers;
starting said campaigns and making said advertisements ready for delivery and display;
registering accounts by said subscribers with said advertising providers;
registering said communication devices by said subscribers with said advertising providers;
for each said communication device, logically dividing parts or all of its device display screens into a plurality of display sections, each of them can be auctioned, leased or rent to host an advertisement based on selection criteria such as category, country, language, device location, personal interest and timeslot such as a number of seconds, minutes, hours and days.
sending requests for advertisement from said communication devices to said advertising providers through advertisement process engines, which can be built-in modules on or downloaded to said communication devices;
receiving responses for advertisement from said advertising providers to said communication devices through said advertisement process engines;
displaying said advertisements on said display sections of said communication devices through said advertisement process engines;
optionally executing click-for-actions for said advertisements on said communication devices by said subscribers;
charging said advertisers by said advertising providers based on contracts or agreements, and impressions or actions for said advertisements during effective timeframes of said campaigns;
distributing advertisement revenues among said subscribers, said advertising providers and said related third party partners by said advertising providers based on contracts or agreements.

12. The method as claimed in claim 11, wherein account registrations from said advertisers and said subscribers, creations of said campaigns and advertisements from said advertisers, device registrations and display section registrations from said subscribers, said requests from and said responses to said advertisement process engines, can be done through communication networks with the portals or application programming interfaces of said advertising providers, or third party interfaces associated with said advertising providers.

13. The method as claimed in claim 11, wherein said subscribers are the owners of said communication devices; wherein said communication devices comprise one or more components of central processing units, system memories, disk storages, input interfaces, output interfaces, network interfaces and system buses. The display screens of said communication devices can be either built-in components or external ones attached to said communication devices.

14. The method as claimed in claim 11, wherein said targeting criteria for said campaigns advertisements from said advertisers comprise one or more characteristics of device manufactures and models, device platforms and operating systems, service providers or operators, countries and languages, data traffic types, categories, device locations, personal interests, online or mobile activities and transactions.

15. The method as claimed in claim 11, wherein said campaigns and advertisements can also come from advertising networks and advertising exchanges.
